(19) United States
(12) Patent Application Publication
(10) Pub. No.: US 2008/0237234 A1
(43) Pub. Date: Oct. 2, 2008

(54) TRASH CAN

(75) Inventors: Frank Yang, Rancho Palos Verdes, CA (US); Joseph Sandor, Santa Ana Heights, CA (US)

Correspondence Address: KNOBBE MARTENS OLSON & BEAR LLP, 2040 MAIN STREET, FOURTEENTH FLOOR, IRVINE, CA, 92614, US

(73) Assignee: SIMPLEHUMAN, LLC, Torrance, CA (US)

(21) Appl. No.: 12/045,641

(22) Filed: Mar. 10, 2008

Related U.S. Application Data
(60) Provisional application No. 60/906,071, filed on Mar. 9, 2007.

(51) Int. Cl. B65F 1/16; B65F 1/00; B65D 43/26

(52) U.S. Cl. 220/263; 220/324

(57) ABSTRACT

A trash can with a lid can include a lock for the lid. The lock can include a latch that cooperates with the trash container body to lock the lid over the opening of the body. The latch can be configured to slide with respect to the edge of the opening of the body from an unlocked position to a locked position. This latch can be integrated into, built into or self contained in the lid. The trash can can also include a pedal actuator for opening the lid. The trash can can also include a damping mechanism mounted to the body of the trash can with a mounting plate. The mounting plate can be made from a material that is harder than the material used for the body of the trash can. Additionally, the trash can can have wheels.

### PRIORITY INFORMATION

This application is based on a claims priority to the U.S. Provisional Patent Application No. 60/906,071 Mar. 9, 2007, the entire contents of which is hereby incorporated by reference.

### BACKGROUND OF THE INVENTIONS

1. Field of the Inventions

The present inventions are directed to lid mechanisms, such as those for trash containers.

2. Description of the Related Art

Receptacles and other devices having lids or doors are used in a variety of different settings. For example, in both residential and commercial settings, trash cans and other devices often have lids or doors for protecting or preventing the escape of the contents of the receptacle. In the context of trash cans, some trash cans include lids or doors to prevent odors from escaping and to hide the trash within the receptacle from view. Additionally, the lid of a trash can help prevent contamination from escaping from the receptacle.

Recently, trash cans with rotary-type motion dampers for slowing the motion of the lids have become commercially available. More specifically, these rotary dampening mechanisms are connected to the lids of the trash cans so as to slow the closing movement of the lids. As such, the trash can is more aesthetically pleasing because the lid closes slowly, thereby preventing a loud slamming noise when the lid is moved to a closing position.

These types of trash cans often are pedal-actuated, i.e., they include a foot pedal which is connected to the lid for moving the lid toward the open position. The rotary mechanisms are connected to the internal linkage connecting the foot pedal to the lid so as to slow the closing movement of the lid.

### SUMMARY OF THE INVENTIONS

An aspect of at least on the embodiments disclosed herein includes the realization that including locking mechanism on the lid of a trash can can overcome certain problems associated with trash can lids. For example, toddlers or pets can accidentally knock over trash cans, thereby allowing the contents to spill out. Aside from accidents, toddlers and pets can also simply decide to explore the contents of the trash container, to their parents' or owners' dismay.

Thus, in accordance with an embodiment, a trash container can comprise a trash can body defining an interior cavity configured to receive trash, the trash can body can have an upper opening through which trash can be inserted into the interior cavity, the trash can body can also including a ledge disposed along at least a portion of an upper periphery of the upper opening, at least a portion of the ledge projecting from a side wall of the trash can body. A lid assembly can be pivotally attached to the trash can body so as to move between opened position and closed positions. The lid assembly can comprise a lid member sized to cover substantially the entire upper opening of the trash can body, at least a portion of the lid member can be spaced from the upper opening when the lid assembly is in the opened position, the lid member covering substantially the entire upper opening when the lid assembly is in the closed position. A latch mechanism can be supported by the lid and can comprise a slidable latch member mounted so as to be slidable relative to the lid member. The latch member can be slidable from a first position in which the latch member engages the ledge so as to lock the lead in the closed position and a second position in which the latch member does not engage the ledge.

Another aspect of at least one of the embodiments disclosed herein includes the realization that when mounting a motion dampening device, such as those used for dampening the motion of a lid of a trash can, to a plastic structure, difficulties can arise in the ability of the plastic material to withstand the forces generated in the vicinity of the dampened device. For example, plastic trash cans are often made from softer, more malleable plastics to allow them to withstand the typical treatment of trash cans (e.g., being overstuffed and deformed by an excess of trash). However, mounting a dampening device to such material presents difficulties in that when large forces are applied to the dampening device, which can be quite small and thus can concentrate such forces, the dampening device can be twisted or moved away from its original position, thereby interfering with the dampening process.

Thus, in accordance with an embodiment, a trash can can comprise a trash can body defining an interior volume configured to receive trash. The trash can body can include an upper opening sized such that trash can be inserted through the upper opening into the interior volume, the trash can body formed from a first material. A lid assembly can be pivotally attached relative to the trash can body so as to be movable between opened and closed positions. The lid assembly can comprise a lid member sized to cover substantially the entire upper opening when the lid assembly is in the closed position. An opening mechanism can be configured to move the lid assembly from the closed to the opened position. A dampening device can be configured to dampen movement of the lid assembly at least from the open position toward the closed position. The dampening device can be mounted to the trash can body with a mounting member, the mounting member made from a second material that is stiffer than the first material.

### BRIEF DESCRIPTION OF THE DRAWINGS

These and other features and advantages of the present embodiments will become more apparent upon reading the following detailed description and with reference to the accompanying drawings of the embodiments, in which:

FIG. 1 is a right perspective view of a step trash can in accordance with an embodiment;

FIG. 2 is a right side view thereof;

FIG. 3 is a front view thereof;

FIG. 4 is a left side view thereof;

FIG. 5 is a rear view thereof;

FIG. 6 is a top plan view thereof;

FIG. 7 is a bottom plan view thereof.

FIG. 8 is a sectional view taken along line 8-8 in FIG. 6.

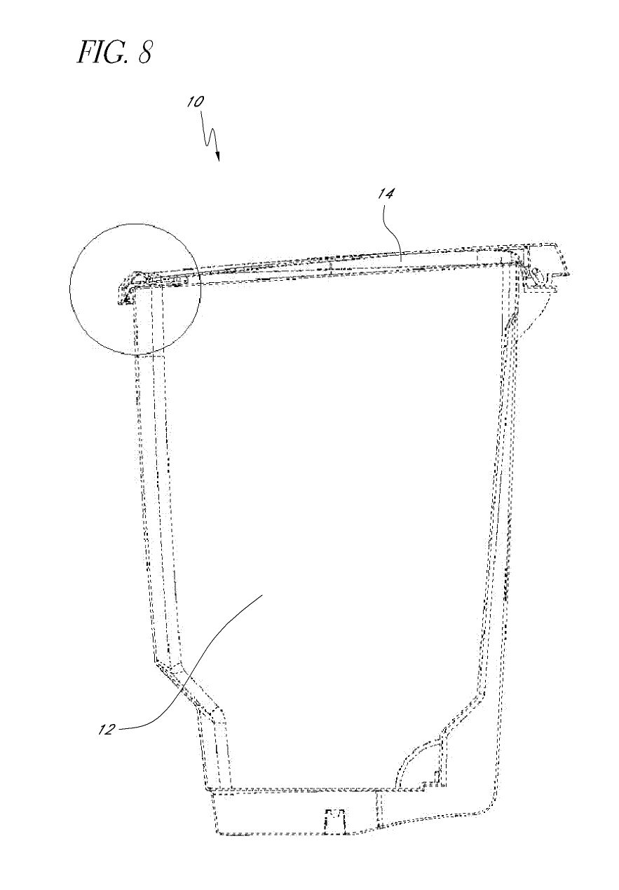

FIG. 9A is a detail sectional view of the step trash can taken along line 9A-9A in FIG. 91B with the lid latch in the unlock position; FIG. 9B is a top view of the lid with the latch in the unlock position.

FIG. 10A is a top view of the step trash can taken along line 10A-10A in FIG. 10B, with the lid latch in the lock position; FIG. 10B is a top view of the lid with the latch in the lock position.

FIG. 11 is a plan view of the underside of the lid with the latch in the unlock position.

FIG. 12 is a plan view of the underside of the lid with the latch in the lock position.

FIG. 13 is a top perspective view of the lid with the latch in the unlock position.

FIG. 14 is a top perspective view of the lid with the latch in the lock position.

FIG. 15 is a front perspective view of the step trash can with the lid open, showing the underside of the lid with the latch in the unlock position.

FIG. 16 is a front perspective view of the step trash can with the lid open, showing the underside of the lid with the latch in the lock position.

FIG. 17 is another right perspective view of the trash can, with the body and wheels removed.

### DETAILED DESCRIPTION OF THE PREFERRED EMBODIMENTS

The inventions disclosed herein are disclosed in the context of a trash can because they have particular utility in this context. However, the inventions disclosed herein can be used in other contexts as well. Further, the inventions are described herein in reference to various embodiments and drawings. It will be appreciated by those skilled in the art that variations and improvements may be accomplished in view of these teachings without deviating from the scope and spirit of the invention. By way of illustration, the present inventions are described in reference to a step-type trash container, or a step trash can of the kind typically used in kitchens, for example. Other types of trash containers, with pivoted lids or removable lids can be used in connection with the present inventions.

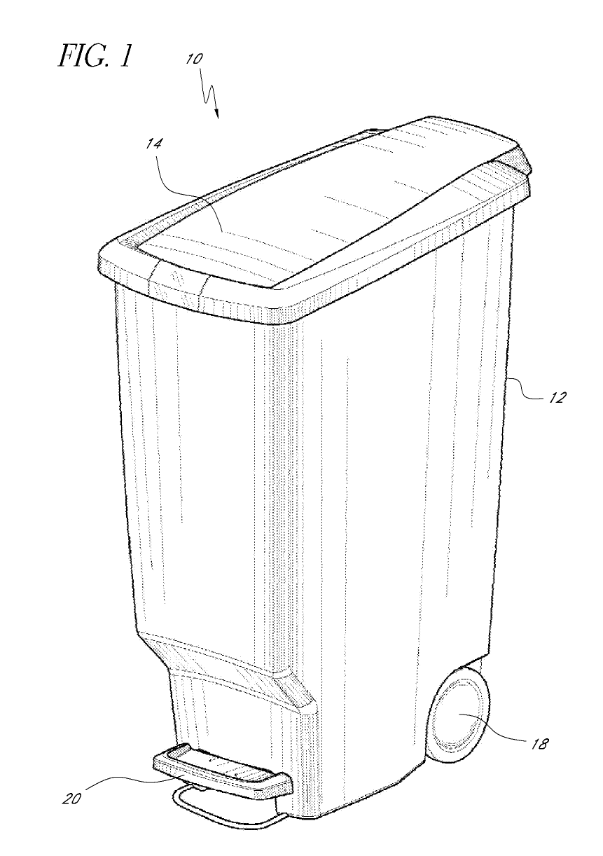

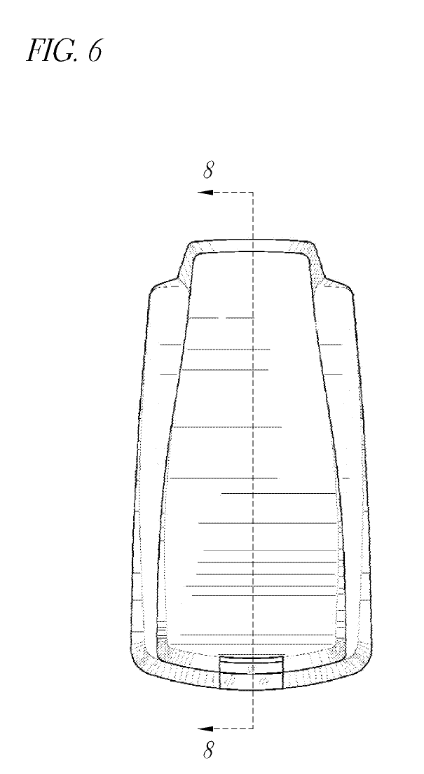

With reference to the drawings, a latch can be included on the lid of a trash container, which can latch onto the edge of the trash container body to lock the lid to the edge of the opening of the body, securely covering the opening. FIGS. 1-7 illustrate the external views of a step trash can 10 in accordance with one embodiment of the present invention.

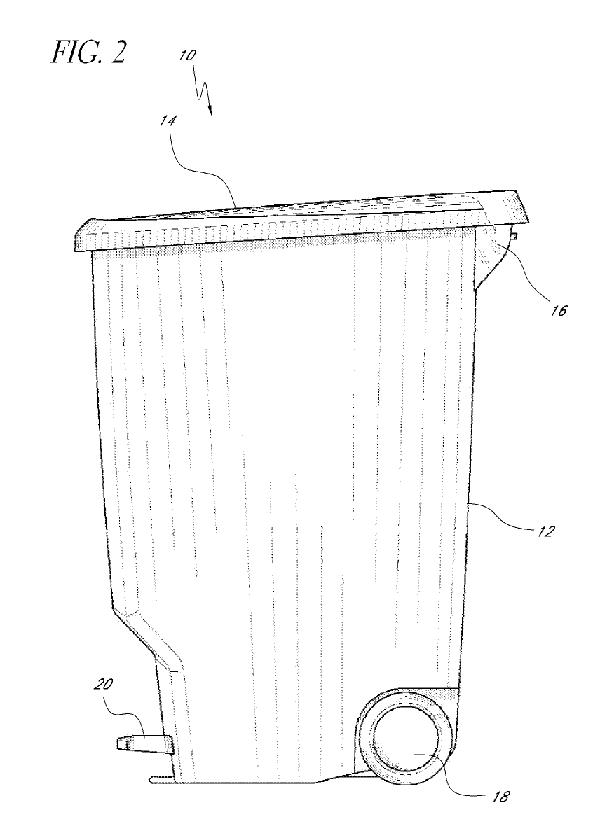

The step trash can 10 can generally have a body 12 and a lid 14 pivotally supported relative to the body. For example, the lid 14 can be hinged to the rear top edge of the body 12, by a hinge 16 shown in FIG. 2. A pair of wheels 18 can be provided to facilitate moving the step trash can 10 along a rolling surface.

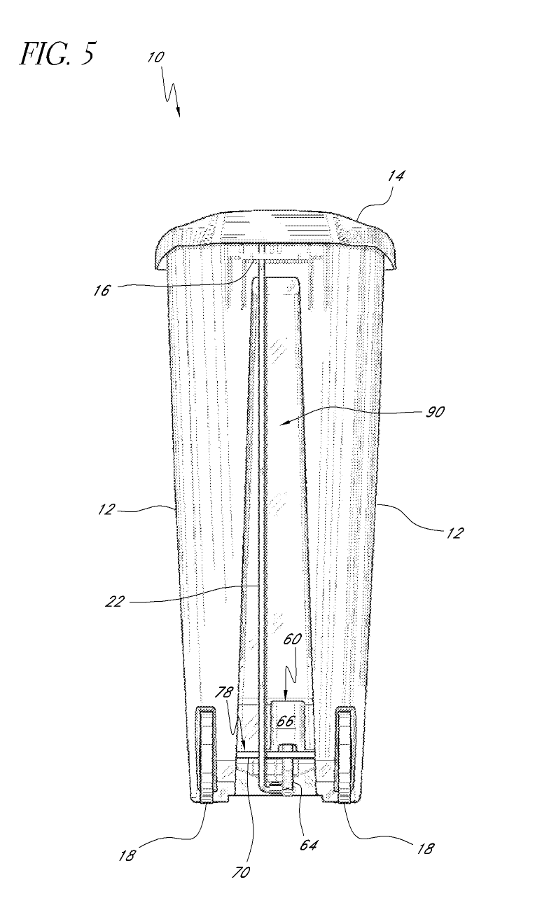

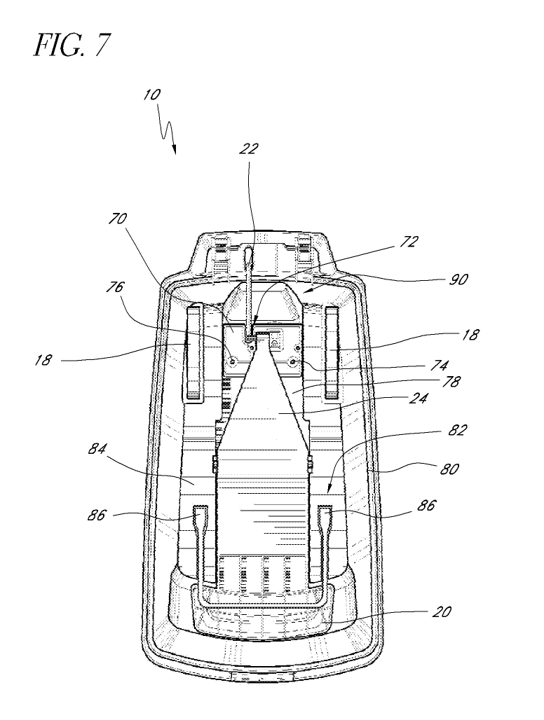

A lid actuator system, which can also be referred to as an opening mechanism, can be provided at the rear of the step trash can 10 to activate pivotal opening of the lid 14 (see FIG. 5), the lid actuator system can include a foot piece (or “pedal”) 20 located near the front base of the body 12. Linkages 22 (see FIG. 5) and 24 (see FIG. 7) which can include a lever member 24 and lifting rod, described in greater detail below, can cooperate to move the lid to 14 from a closed to an open position. Other than the embodiment of lid actuator system illustrated, other lid actuator system known in the art may be deployed without departing from the scope and spirit of the present inventions. The lid 14 can include a lid latch 30, which can be integrated into, built into or self contained in the lid (as opposed to a separate external locking piece for the lid).

In some embodiments, the latch 30 can be configured to slide with respect to the edge of the opening of the body from an unlocked position to a locked position. The sliding support interface between the latch and the lid can be provided with structures (e.g., indent and complementary locking tabs) that positively index the latch in the locked and unlocked positions. However, other configurations can also be used.

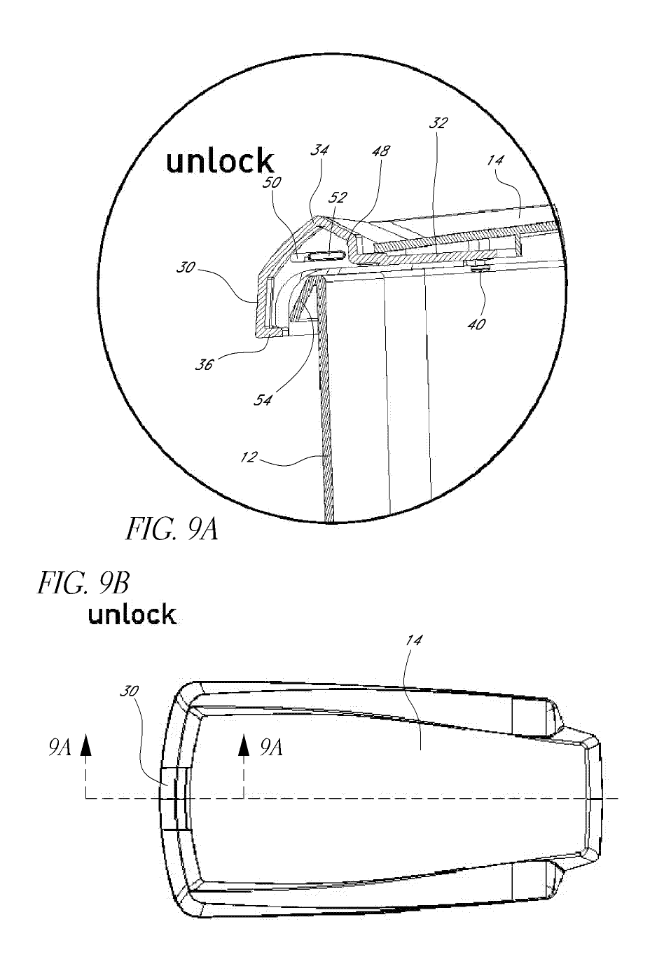

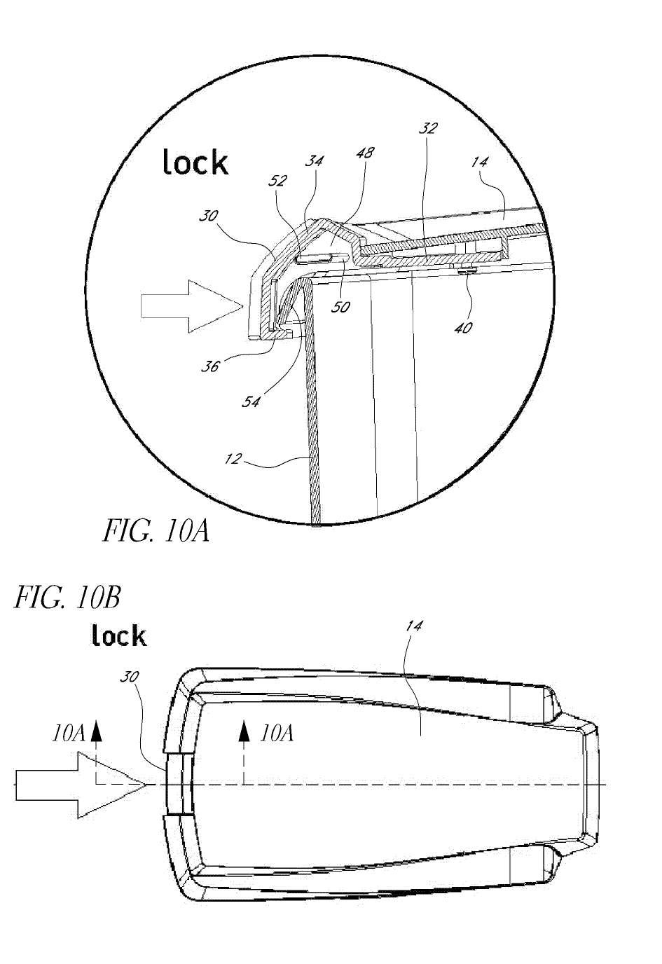

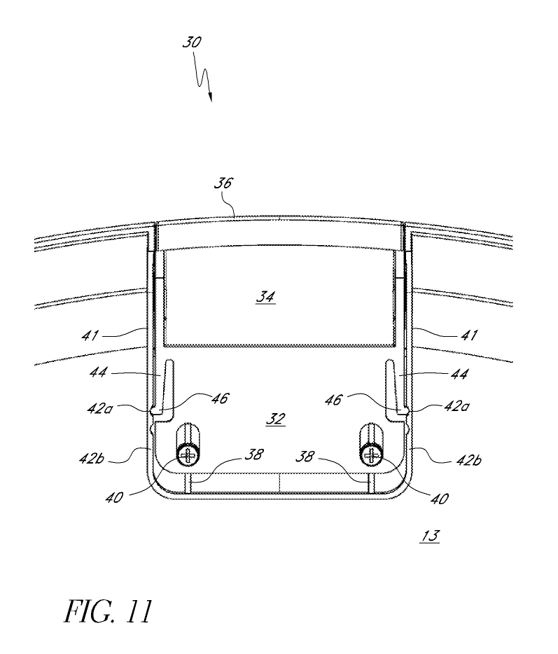

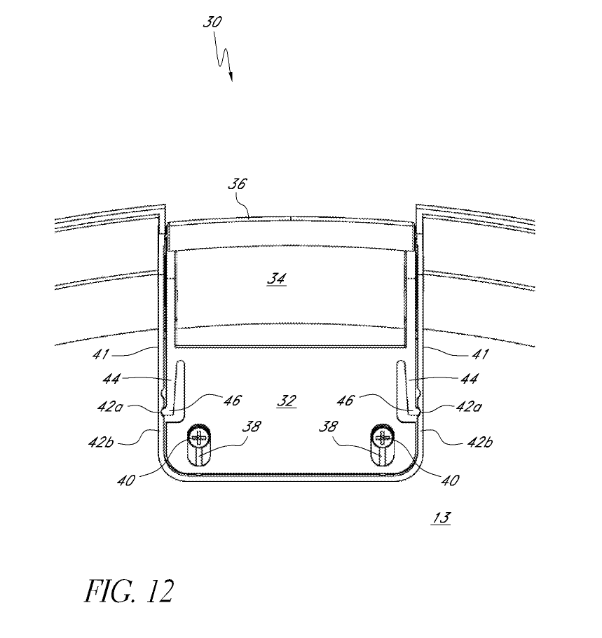

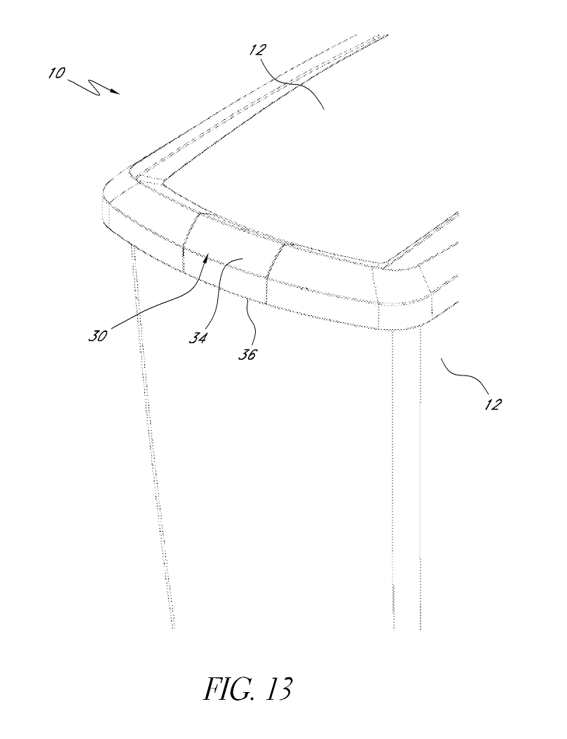

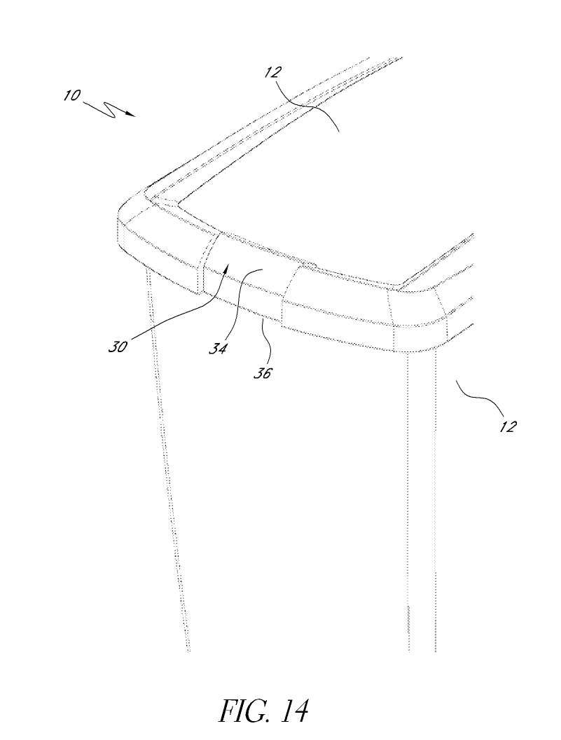

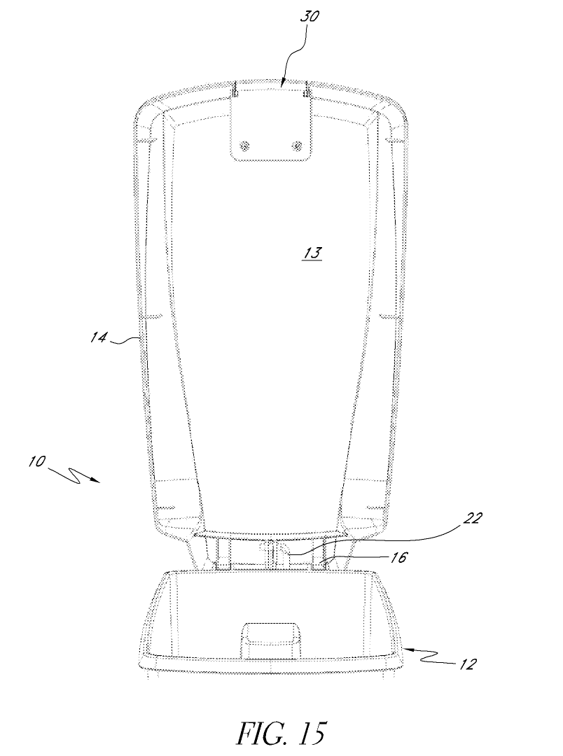

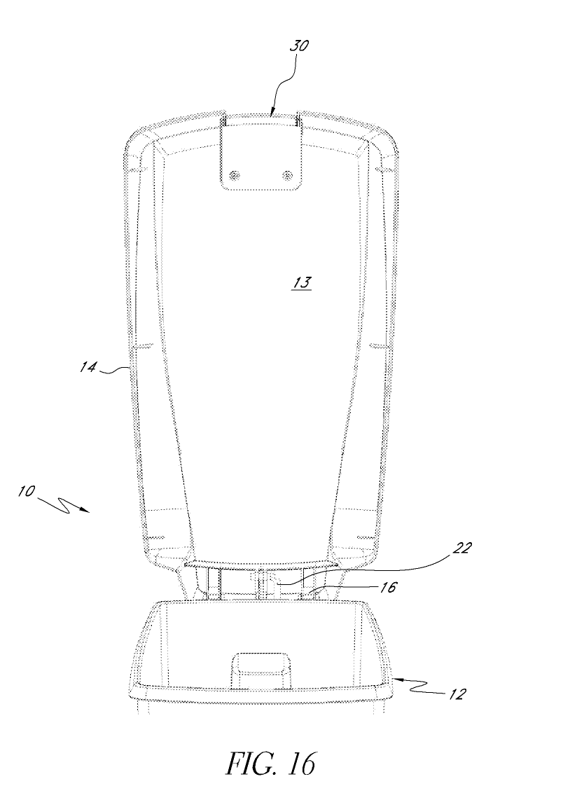

FIGS. 9, 11, 13 and 15 illustrate the lid latch mechanism 30 in the opened/unlock position. FIGS. 10, 12, 14 and 16 illustrate the lid latch mechanism 30 in the closed/lock position. FIGS. 15 and 16 illustrate the lid 14 opened from the body 12, showing the underside 13 of the lid 14. FIGS. 11 and 12 illustrate in greater detail the sliding movements of the latch 30 with respect to the lid 14. FIGS. 13 and 14 illustrate the top perspective view of the latch 30 with respect to the lid 14. FIGS. 9 and 10 illustrate the sliding movements of the latch 30 with respect to the body 12.

Referring to FIGS. 11, 12, 9A and 10A, the latch 30 can comprise a plate section 32, a bent section 34, and a lip 36. The bent section 34 can be exposed externally, as illustrated in FIG. 13, and can have a profile that is flush with the profile of the adjacent structure of the lid 12, thereby providing an aesthetically pleasing and appealing structure. The plate section 32 can be provided with two slotted holes 38. The plate section 32 can be slidably attached to the underside 13 of the lid 14 near the front edge thereof, by two retaining screws 40 anchored to the underside 13 of the lid 14.

The slotted hole 38 can be sized to allow the screws 40 to slide relatively within the slotted holes 38, thereby allowing the plate section 32 to slide relative to the edge of the lid 14, from the opened/unlock position shown in FIG. 11 to the closed/lock position shown in FIG. 12. Further, at the sides 48 of the bent section 34 of the latch 30 (see FIGS. 9A and 10A), slotted holes 50 can be provided to receive a stub 52 anchored at the adjacent section of the lid 14.

The slotted hole 50 can be sized to allow the stub 52 to slide relatively within the slotted holes 50, thereby further supporting sliding movement of the latch 30 (i.e., the sides 48 of the bent section 34 of the latch 30 to slide relative to the lid 14, from the open unlock position shown in FIG. 9A to the closed/lock position shown in FIG. 10A.

Detents 42a and 42b can be provided on the edges 41 at the front section of the lid 14. The plate section 32 of the latch 30 has at each side, extending spring tabs 44 that are biased outward away from the plate section 32. The tabs 44 can be provided with a detent with a rounded tip 46 that protrudes and can be received in the indentations 42a or 42b.

As the plate section 32 slides from an opened/unlock position to a closed/lock position, the tip 46 moves from a lodged position in indentation 42a as shown in FIG. 11, to be lodged in indentation 42b as shown in FIG. 12, thereby indexing the latch 30 from one position to another. The spring bias in the tab 44 is configured such that sufficient force is applied to lodge the tip 46 in the indentations 42a and 42b at the respective positions, to securely hold the latch 30 in place at the respective positions.

The periphery of the opening of the body 12 can have an outwardly extending flange or ledge 54. In the open/unlock position shown in FIG. 9A, the lip 36 of the latch 30 is released (i.e., does not catch) from the ledge 54, allowing the lid 14 to be opened with respect to the body 12. In the closed/lock position shown in FIG. 10A, the lip 36 of the latch 30 is latched onto (i.e., catches) the ledge 54, thereby locking the lid 14 against the body 12. Some embodiments, the ledge 54 is formed from an upper portion of the side wall of the body 12. The upper portion can extend hourly from the internal cavity defined by the body 12. Additionally, stiffening ribs (not shown) can extend between the ledge 54 and the outer surface of the body 12 to enhance the stiffness of the ledge 54.

While the above described embodiments are directed to deployment of the inventive latch in a step-type trash container having a pivoted lid, it is understood that the inventive latch can be used in a trash container that has a lid that is not attached to the container body, such as a lid that is removed or separated from the container body when opening the lid.

In some embodiments, the trash can 10 can include a damping mechanism 60 configured to dampen the movement of the lid 14. In some embodiments, the damping mechanism 60 can be disposed at an end of the lever member 24 connecting the pedal 20 with the linkage 22. In some embodiments, the linkage 22 can a lifting rod. The lifting rod 22 can be connected to an end of the lever member 24 that is opposite the pedal 20. As such, when a user depresses the pedal 20, the lever member 24 pivots about a pivot member 62, thereby causing the lifting rod 22 to rise and thereby open the lid 14.

As shown in FIG. 5, the damping mechanism 60 can have a piston rod portion 64 and a cylinder portion 66. The construction and operation of this type of damping mechanism is disclosed in U.S. Patent Publication No. 2007/0012699 which is hereby incorporated by reference. Thus, a detailed description of the damping mechanism 60 is not included herein.

In some embodiments, the lower end of the piston rod 64 is also connected to the end of the lever member 24 that is opposite the pedal 20. In other embodiments, the lower end of the piston rod 64 is connected to an end of the lifting rod 22. As such, when a user steps on the pedal 20, the end of the lever member 24 connected to the lifting rod 22 rises, thereby opening the lid by raising the lifting rod 22, and causing the piston rod 64 to rise, thereby also moving the piston within the cylinder 66. As such, the damping mechanism provides resistance to the upward movement of the lifting rod 22. Additionally, the damping mechanism 60 dampens the movement of the lid toward the closed position by slowing the downward movement of the lifting rod 22. Due to the damping provided by the damping mechanism 60, the damping mechanism itself can experience significant loads.

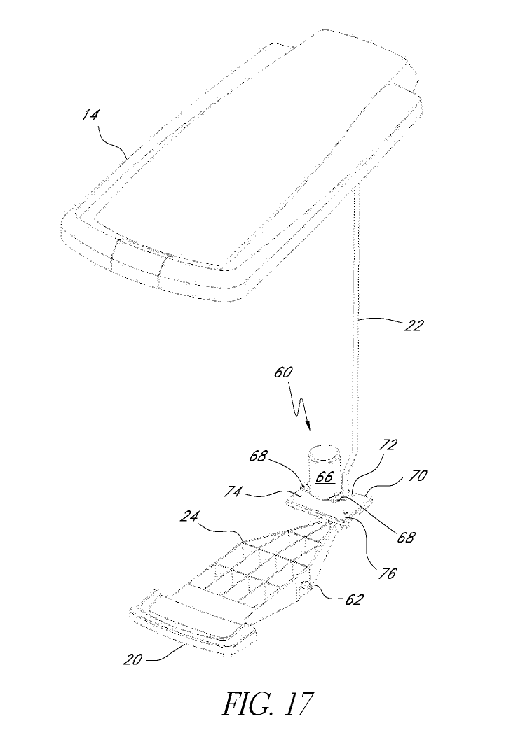

With continued reference to FIG. 17, a cylinder portion 66 can include a plurality of flanges 68. The mounting flanges 68 can be used to secure the cylinder member 66 in a fixed position relative to the body 12.

Often, the bodies of trash can are made from softer, more malleable plastics, such as high impact polypropylene or other relatively softer plastic materials. However, other hardnesses can also be used.

Thus, because these types of plastics are soft, if the cylinder member 66 is attached directly to the body 12, the cylinder 66 is more likely to move or twist under the loads generated during operation of the pedal 20 and the closing movement of the lid 14. Additionally, such softer materials can fail from fatigue.

Thus, to provide a more secure and reliable attachment of the damping mechanism 62 to the body 12, the trash can also include a mounting platform 70. In some embodiments, the mounting platform can be made from material that is harder than the material used to make the body 12. For example, but without limitation, the mounting platform 70 can be made from Acrylonitrile Butadiene Styrene (ABS) plastic, or other materials.

The mounting platform 70 can include an opening 72 such as a groove or an aperture configured to allow the lifting rod 22 to freely move up and down as the user steps on or releases the pedal 20. Additionally, the cylinder member 66 can be attached to the mounting platform 70 using the flanges 68 and any type of fastener.

The mounting platform 70 can be connected to the body 12 in any known manner. In some environments, the mounting platform 70 can include apertures 74, 76 through which threaded fasteners can extend to attach the platform 70 to the body 12.

In some embodiments, the body 12 can include a downwardly facing surface 78 (FIG. 7). The mounting platform 70 can be attached to the downwardly facing surface 78, for example, with fasteners extending through the holes 74, 76. Additionally, the mounting platform 70 can also be glued to the lower surface 78.

With the mounting platform 70 attached to the downwardly facing surface 78, when the pedal 20 is depressed and the lifting rod 22 and the piston rod 64 are raised, all of the associated forces imparted to the mounting platform 70 are transferred to the downwardly facing surface 78 of the body 12. This provides the attachment of the damping member 60 to the body 12 with enhanced strength that can better withstand the forces generated because a user can step on the pedal 20 with all of their weight. Thus, the upward movement of the piston rod 64 can be quite fast, and thus can cause significant forces on the mounting member 70.

When the pedal 20 is released, thereby allowing the lid 14 to close, the lifting rod 22 falls along with the piston rod 64. The devices within the cylinder member 66 slow this movement and thus also in part loads onto the plate 70. These loads are transferred to the body 12 through the fasteners and/or any other attachment means for attaching the plate 70 to the body 12.

In some embodiments where the plate 70 is made from a harder material than that used for the body 12, the plate 70 does not deform as much. Thus, the damping mechanism 60 performs more reliably and consistently.

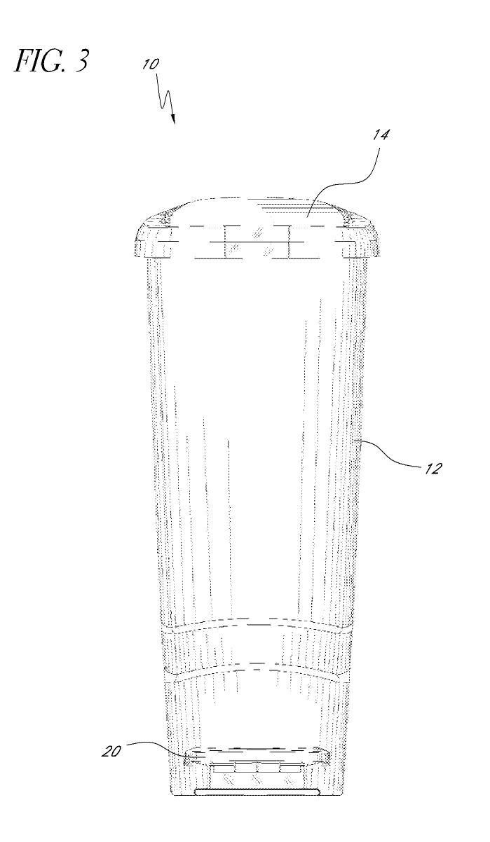

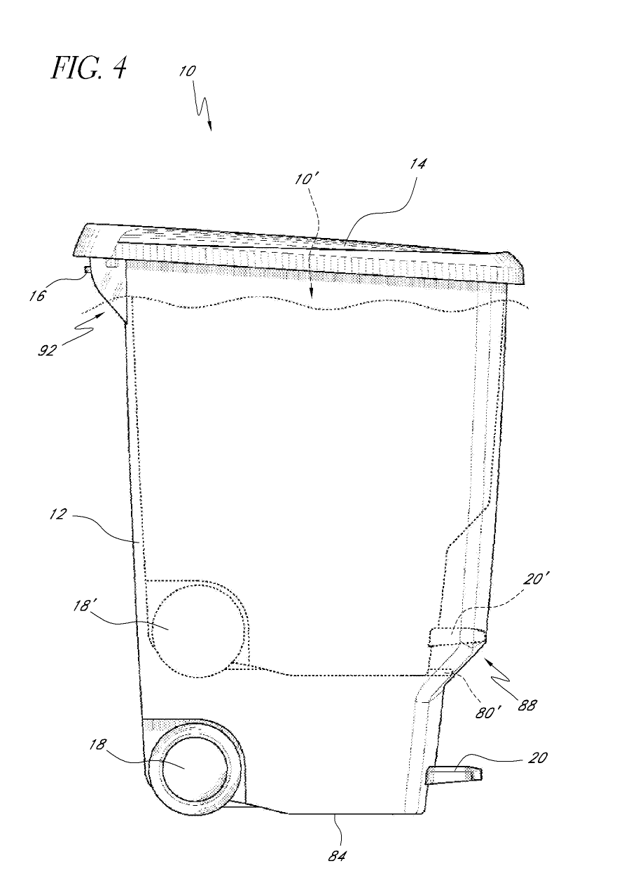

In some embodiments, the trashcan 10 can be configured to be stackable. For example, the trashcan body 12 can have a tapered shape, expanding outwardly and upwardly. For example, as shown in the front elevational view of FIG. 3 and the right side elevational view of FIG. 4, the outer surfaces of the body 12 can be tapered outwardly and upwardly. As such, with the lid 14 removed, a plurality of the trashcan bodies 12 can be stacked one within another.

With reference to FIG. 7, the trashcan 10 can be configured such that the features near the bottom of the trashcan 10 fall entirely within a footprint of the upper portion of the side wall forming the body 12. For example, as shown in FIG. 7, the pedal 20 and the wheels 18, as seen in a bottom plan view, fall entirely within a periphery 80 defined by an upper portion of the side wall forming the body 12. As such, when one trashcan 10 is stacked within another, the pedal 20 and the wheels 18 can fit within the cavity of another trashcan.

In some embodiments, the trashcan 10 can include a pedal protector 82 (shown in phantom). The pedal protector 82 can be attached to the lower surface 84 of the body 12. In some embodiments, the pedal protector 82 can be fixed to the lower surface 84 with threaded fasteners, such as screws, extending through apertures a six disposed in tens of the protector 82. However, other devices can also be used for fixing the protector 82 to the lower surface 84.

The protector 82 can be in the form of a U-shaped bar. Additionally, the lower surface 84 can include a recessed channel (not shown) into which the protector 82 can fit. As shown in FIGS. 4 and 7, the bight of the protector 82 can be positioned so as to extend under the pedal 20. As such, when one trashcan 10′ is stacked within another trashcan 10, the protector 80′ can prevent the pedal 20′ from contacting other portions of the interior of the trashcan 10.

In some embodiments, the trashcan 10 can include a brow portion 88 which extends over the pedal 20. In such embodiments, the interior surface of the brow portion 88, can serve as a resting place for the pedal protector 80′ when the trashcan 10′ is nested within the trashcan 10.

With continued reference to FIGS. 5 and 7, a rear surface of the body 12 can include a channel 90 configured to receive the lifting rod 22. As such, the lifting rod 22 is better protected when the trashcan 10 is stacked within another.

With reference to FIG. 4, the trashcan 10 can also include a rear projecting portion 92. The rear projecting portion can also help in protecting the lifting rod 22 when the trashcan 10 is stacked within another. For example, the projecting portion 92, when the trashcan 10 is stacked within another, will contact the upper peripheral edge of the body of another trashcan, thereby preventing any portion of the lifting rod 22 from contacting the upper peripheral edge of another trashcan.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combinations or sub-combinations of the specific features and aspects of the embodiments can be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

What is claimed is:

1. A trash container comprising:
a trash can body defining an interior cavity configured to receive trash, the trash can body having an upper opening through which trash can be inserted into the interior cavity, the trash can body also including a ledge disposed along at least a portion of an upper periphery of the upper opening, at least a portion of the ledge projecting from a side wall of the trash can body;
a lid assembly pivotally attached to the trash can body so as to move between opened position and closed positions, the lid assembly comprising:
a lid member sized to cover substantially the entire upper opening of the trash can body, at least a portion of the lid member being spaced from the upper opening when the lid assembly is in the opened position, the lid member covering substantially the entire upper opening when the lid assembly is in the closed position; and
a latch mechanism supported by the lid, the latch mechanism comprising a slidable latch member mounted so as to be slidable relative to the lid member, the latch member being slidable from a first position in which the latch member engages the ledge so as to lock the lead in the closed position and a second position in which the latch member does not engage the ledge.

2. The trash container according to claim 1, wherein the latch is integrated with the lid.

3. The trash container according to claim 1, wherein the latch is disposed on the front edge of the lid.

4. The trash container according to claim 1, wherein the lid is attached to the body with a hinge, the latch being disposed on a side of the lid opposite the hinge.

5. The trash container according to claim 1, wherein the body is made from a first material, and the latch is attached to the lid with a mounting member made from a second material that is stiffer than the first material.

6. The trash container according to claim 5, wherein the first material is impact resistant polypropylene and the second material is Acrylonitrile Butadiene Styrene (ABS).

7. The trash container according to claim 6 additionally comprising a pedal actuator configured to move the lid between opened and closed positions, the pedal actuator including a lever member made from ABS and a dampening device mounted to the body with a mounting plate made from ABS.

8. The trash container according to claim 1, wherein the ledge comprises an upper portion of the trash can body extending outwardly from the internal cavity and stiffening ribs attaching the upper portion to an outer surface of the trash can body.

9. The trash container according to claim 1 additionally comprising a pedal actuator assembly comprising a pedal and being configured to raise the lid when the pedal is depressed, and a fixed pedal protector member extending beneath the pedal.

10. A trash can comprising:
a trash can body defining an interior volume configured to receive trash, the trash can body including an upper opening sized such that trash can be inserted through the upper opening into the interior volume, the trash can body formed from a first material;
a lid assembly pivotally attached relative to the trash can body so as to be movable between opened and closed positions, the lid assembly comprising a lid member sized to cover substantially the entire upper opening when the lid assembly is in the closed position;
an opening mechanism configured to move the lid assembly from the closed to the opened position;
a dampening device configured to dampen movement of the lid assembly at least from the open position toward the closed position, the dampening device being mounted to the trash can body with a mounting member, the mounting member made from a second material that is stiffer than the first material.

11. The trash can according to claim 10, when the first material is impact resistant polypropylene and the second material is ABS.

12. The trash can according to claim 10, wherein the mounting member includes an opening, a portion of the opening mechanism extending through the opening.

13. The trash can according to claim 10, wherein the opening mechanism comprises a pedal assembly and a connector extending between the pedal assembly and the lid member.

14. The trash can according to claim 13, wherein mounting member includes an opening, the connector extending through the opening.

15. The trash can according to claim 10, wherein the trash can body includes a downwardly facing surface, the mounting member being attached to the downwardly facing surface.

16. The trash can according to claim 10, wherein the dampening mechanism comprises a cylinder member attached to the mounting member and a piston rod attached to the opening mechanism.

17. The trash can according to claim 10 additionally comprising a latch mechanism configured to lock the lid assembly in the closed position.

18. The trash can according to claim 17, wherein the latch mechanism is attached to a forward edge of the lid member.

19. The trash can according to claim 10, wherein the opening mechanism comprises a pedal actuator assembly comprising at least a pedal configured to raise the lid when the pedal is depressed, and wherein the trash can further comprises a fixed pedal protector member mounted beneath the pedal.
